(19) United States
(12) Patent Application Publication
(10) Pub. No.: US 2012/0243519 A1
(43) Pub. Date: Sep. 27, 2012

(54) SOLVING A HIDDEN NODE PROBLEM DUE TO TRANSMISSION POWER IMBALANCE

(75) Inventors: Timo Koskela, Oulu (FI); Sami-Jukka Hakola, Kempele (FI); Samuli Turtinen, Ii (FI)

(73) Assignee: Renesas Mobile Corporation

(21) Appl. No.: 13/053,871

(22) Filed: Mar. 22, 2011

(51) Int. Cl. H04W 84/02

(52) U.S. Cl. 370/338

(57) ABSTRACT

The present invention discloses an apparatus, a method and a computer program for resolving a hidden node problem in relation to handshake message transferring e.g. in WLAN networks. In one embodiment of the invention, the apparatus receiving a Clear to Send (CTS) message repeats the message after a Short Interframe Space (SIFS) time period. Stations not directly hearing the original CTS due to a low power are able to receive the repeated CTS and defer their transmissions accordingly. In another embodiment, the apparatus receiving the CTS message indicates in its Ready to Send (RTS) message that the CTS sender station has a low transmitting power. With this knowledge, the other present stations can defer their transmissions until they are sure that the data transfer between the first two stations having the RTS-CTS messaging has not been initiated or is already completed.

### BACKGROUND OF THE INVENTION

1. Field of the Invention

The present invention relates to mobile communication networks, and especially to a frequency band usage in e.g. WLAN networks, and further, to a situation where at least one network device has a lower maximum transmitting power than is expected.

2. Description of the Related Art

In mobile communication networks, different frequency bands are a resource which is tightly governed between different users and applications. The governing institutions include several standardizing organizations and e.g. in the USA, the governing institution is the Federal Communications Commission (FCC). Therefore, specific bands are allocated for e.g. 3 G, 4 G and for WLAN usage. Also, there are specific frequency bands allocated e.g. for TV broadcasting. We may consider that for certain specific mobile communication application, some parts of the spectrum are licensed for it and the rest of the spectrum forms an unlicensed band(s).

Regarding radio frequency bands in general, different frequency bands can be licensed to a certain use, or they can be unlicensed. Unlicensed band is basically a shared spectrum where one needs to accept interference from other unknown systems and sources such as in ISM (industrial, scientific and medical) bands. As licensed band operation has been increasingly utilized, portions of the radio spectrum that remain available have become limited. Thus, operators, service providers, communication device manufacturers, and communication system manufacturers, are all seeking efficient solutions to utilize unlicensed shared bands. Communication on an unlicensed shared band is generally based on sharing an available radio channel between different communication devices. Different communication devices may utilize a common radio access technology (RAT), but it is also possible that different communication devices utilize different RATs which may have different kinds of limitations and different rules in their operation. In an unlicensed shared band, channel access can be distributed in a manner, where communication devices can be configured to detect a channel, and utilize a channel reservation scheme known to other communication devices in order to reserve a right to access the channel.

Unlicensed bands are naturally shared spectra where one needs to accept interference originating from other unknown systems and interference sources such like different devices applying ISM bands.

One potential and attractive spectrum opportunity includes TV white spaces (TVWS) which mean frequency bands allocated for television broadcasting signal usage, but which are locally free in a desired geographical area.

The FCC has defined two concepts for helping to find available channels; a TV band database and a geo-location capability. A TV band database that maintains records of all authorized services in the TV frequency bands, is capable of determining the available channels according to a specific geographic location and it provides lists of available channels to TV Band Devices (TVBD) that have been certified under the FCC's equipment authorization procedures. The geo-location capability is defined for some of the TVBDs. A TVBD with such capability should be able to determine its geographic coordinates within certain level of accuracy which can be e.g. ±50 m. The geo-location capability is used with a TV bands database to determine the availability of TV channels at a location of the TVBD.

Several types of TVBDs have been defined by FCC based on their characteristics. In the USA, the general frequency range for television use is between 54-698 MHz.

The first type of TVBDs is a fixed device. A fixed TVBD is located at a specified fixed location. The fixed TVBD is able to select a channel from the TV bands database. Furthermore, it is able to initiate and operate a network by sending enabling signals to other fixed TVBDs or personal/portable TVBDs. Additionally, it is able to provide a list of available channels to a Mode I personal/portable device (see below) on which the Mode I device may operate, especially a supplemental list of available channels for Mode I devices. Such a supplemental list may contain available TV channels that are adjacent to occupied TV channels, for which the fixed TVBDs cannot operate. Finally, the fixed device may be e.g. an access point.

The second type of TVBDs is a Mode I personal/portable device. Such a device does not use any internal geo-location capability and or access to a TV bands database, so it must obtain a channel list from either a fixed TVBD or from Mode II personal/portable TVBD (see below). This kind of device may work only as a client/slave, but not as a master.

The third type of TVBDs is a Mode II personal/portable device. A Mode II personal/portable device has similar functions as the fixed TVBD, but it does not need to transmit or receive signals at a specified and fixed place. This kind of TVBD is e.g. an access point.

The fourth type of TVBDs is a sensing only device. It is a personal/portable TVBD that uses spectrum sensing for determining a list of available channels. It can use frequency bands 512-608 MHz (in USA, TV channels 21-36) and 614-698 MHz (US TV channels 38-51). It is notable that spectrum sensing is only defined for personal/portable TVBDs.

The transmission power limits are given as follows. For fixed TVBDs, the maximum power delivered to the transmitting (TX) antenna shall not exceed 1 W. For personal/portable TVBDs, the maximum effective isotropic radiated power (EIRP) is 100 mW (20 dBm). If the personal/portable TVBD does not meet the adjacent channel separation requirements (the distance between the TVBD and the TV station is smaller than the minimum distance requirement), the maximum EIRP is set to 40 mW (16 dBm).

The maximum power spectral densities (for any 100 kHz band during any time interval of continuous transmission) for different types of TVBDs are given for fixed devices as 12.2 dBm, for personal/portable devices operating adjacent to occupied TV channels as −1.6 dBm, for sensing only devices as −0.8 dBm and for all other personal/portable devices as 2.2 dBm.

IEEE technologies represent a very attractive choice for the TVWS due to their listen-before-talk nature to provide an inbuilt Physical Layer (PHY)/Medium Access Control (MAC) level co-existence in unlicensed spectrum. The IEEE projects like 802.22, 802.11af, 802.19.1 and 1900.4a have undertaken actions to address the White Space issues from different points of view.

In prior art, using a Wireless Local Area Network (WLAN), a “Ready to Send-Clear to Send” (RTS-CTS) message exchange is used to prevent so-called hidden terminal problems in ad hoc type communication situations. Hidden node problem occurs when certain nodes, e.g. in FIG. 1, nodes C and D are unaware of the node A and they interfere node A's reception with their simultaneous and overlapping transmission. Usually, the RTS-CTS procedure prevents this from happening but however, in order to run the procedure successfully, the RTS and CTS transmissions should be made with equal power so that other nodes in the vicinity are able to detect these messages and act accordingly (e.g. by delaying their transmission). In TVWS, the geographic location or device categorization, like an access point being a fixed device and the User Equipment (UE) being a mode I/II device, imposes some limitations as discussed earlier. Now in the prior art situation shown in FIG. 1, the node A is a TVBD having a low TX power (seen as the signal range 10 centered by node A) and thus, it cannot use the same TX power as nodes B, C and D which are in this scenario, high-TX-power TVBDs (transmission range from node B is shown as 11 and transmission range from node C is seen as 12). This effectively means that the Clear to Send (CTS) message 10 from node A is not heard by node C or by node D. Considering now the virtual carrier sensing (virtual means that the nodes will know, how long the channel is occupied and they do not try to access the channel during this phase), it is activated upon reception of CTS, DATA or acknowledgement (ACK) message. In this situation, C and D don't hear the A's CTS message 10 and thus, they act as the channel was available after waiting a DCF Interframe Space (DIFS) period. Node B does not know that C and D did not hear the transmission and thus, node B initiates its own transmission 11 resulting in that both transmissions, from B to A 11 and from C to D 12 will fail.

Also, the WLAN RTS-CTS handshake mechanism prior to data transmission is depicted in FIG. 2. At first, a Ready to Send (RTS) message is sent from a source (Src) to a destination (Dest). This is followed by a Clear to Send (CTS) message by the destination after a short while after the RTS message ends. When the RTS-CTS handshake is confirmed, in other words, both messages have been successfully transferred, data transmission can be initiated from the source after a short while after the CTS message. When the data transmission is finished, an acknowledgement (Ack) message is sent by the destination. FIG. 2 also indicates a utilization of a Network Allocation Vector (NAV) for other nodes, marked as “Other”, present in the vicinity of Src and Dest. The NAV indicates that the medium is busy. The NAV for RTS starts in the end of the RTS and ends when the Ack message ends. The NAV for CTS starts in the end of the CTS and ends when the Ack message ends. More specifically, duration field in RTS and CTS frames distribute “medium reservation” information which is stored in the NAV. In case node “Other” desires to send a transmission, it has to be deferred at least until the NAV is released. The following time slot is marked as a next MAC protocol data unit (MPDU).

### SUMMARY OF THE INVENTION

According to one aspect of the present invention, it introduces an apparatus, which is configured to receive a message which message is transmitted by a first station; indicate from the message that the first station transmits with a lower transmitting power than the apparatus, the first station deemed as a hidden node; transmit information comprising an indication of the hidden node, where the indication is received by at least one other station; and as a consequence to the received indication, the at least one other station is configured to defer its data transmission.

In an embodiment of the invention, the apparatus is further configured so that the indication of the hidden node is the transmission of the first station repeated by the apparatus.

In an embodiment of the invention, the apparatus is further configured to transmit the information with larger power than the first station.

In an embodiment of the invention, the apparatus is further configured so that the indication of the hidden node is included in a part of a transmitted message by the apparatus.

In an embodiment of the invention, the apparatus is further configured so that the received message comprises information of at least one of a device class, transmission power class or maximum transmitting power of the first station.

In an embodiment of the invention, the apparatus is further configured so that the transmitted information comprises power level information comprising at least one of a device class, transmission power class or maximum transmitting power of the apparatus.

In an embodiment of the invention, the apparatus is further configured so that in case the power level information does not match with the power of the received message, the received message is repeated by the apparatus.

In an embodiment of the invention, the message transmitted by the first station is a Clear to Send message.

In an embodiment of the invention, the transmitted information comprises a Ready to Send message.

In an embodiment of the invention, the Ready to Send message is transmitted with the same power as the repeated transmission.

In an embodiment of the invention, the data transmission is deferred for a selectable time period.

In an embodiment of the invention, the time period is selected as two times the Short Interframe Space plus the frame duration of the Clear to Send message.

In an embodiment of the invention, in case a data transmission after the Ready to Send message takes place by the apparatus, the at least one other station is configured to defer its transmission until the data transmission by the apparatus is completed and acknowledged.

In an embodiment of the invention, the apparatus, the first station and the at least one other station are TV Band Devices.

In an embodiment of the invention, the apparatus, the first station and the at least one other station are part of a Wireless Local Area Network.

According to another aspect of the invention, there is provided a method which comprises receiving a message which message is transmitted by a first station; indicating from the message that the first station transmits with a lower transmitting power than the apparatus, the first station deemed as a hidden node; transmitting information comprising an indication of the hidden node, where the indication is received by at least one other station; and as a consequence to the received indication, the at least one other station is configured to defer its data transmission.

In an embodiment of the invention, the indication of the hidden node is the transmission of the first station repeated by the apparatus.

According to yet another aspect of the invention, there is provided a computer program comprising code adapted to perform the following steps, when executed on a data-processing system. These steps comprise receiving a message which message is transmitted by a first station; indicating from the message that the first station transmits with a lower transmitting power than the apparatus, the first station deemed as a hidden node; transmitting information comprising an indication of the hidden node, where the indication is received by at least one other station; and as a consequence to the received indication, the at least one other station is configured to defer its data transmission.

In an embodiment of the invention, the indication of the hidden node is the transmission of the first station repeated by the apparatus.

In an embodiment, the computer program is stored on a computer readable medium.

It is possible to combine one or more of the embodiments and aspects disclosed above to form one or more further embodiments of the present invention.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. The examples shown in the drawings are not the only possible embodiments of the invention and the invention is not considered to be limited to the presented embodiments. In the drawings:

FIG. 1 illustrates a prior art setting of a hidden node due to power imbalance in RTS-CTS handshake message exchange,

FIG. 2 illustrates a WLAN RTS-CTS handshake mechanism prior to the data transmission according to the prior art,

FIG. 3 illustrates a first embodiment of the invention which applies CTS repetition,

FIG. 4 illustrates a second embodiment of the invention which applies low power CTS indication in the RTS message,

FIG. 5 illustrates an exemplary signaling option according to the first embodiment of the invention, by CTS repetition with low power indication, and

FIG. 6 illustrates an exemplary signaling option according to the second embodiment of the invention, by a signaling illustration of the low-power-RTS-receiver.

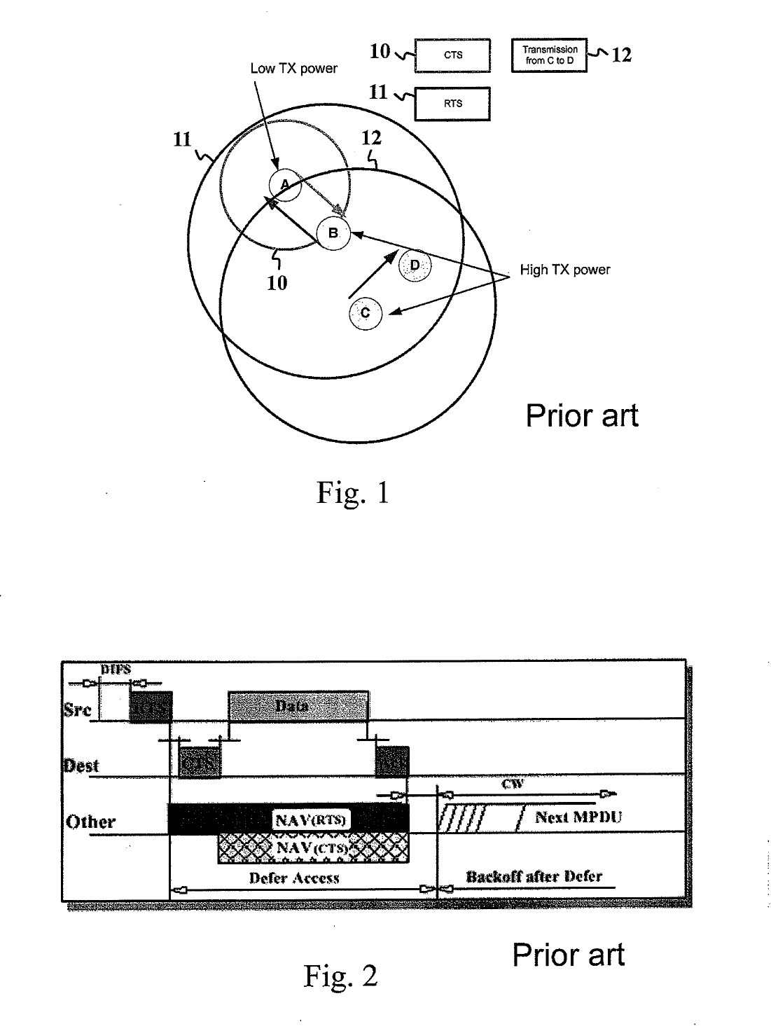

### DETAILED DESCRIPTION OF THE EMBODIMENTS

Reference will now be made in detail to the embodiments of the present invention, examples of which are illustrated in the accompanying drawings.

The present invention introduces an apparatus, a method and a computer program for resolving a hidden node problem (in other words, a hidden station problem) due to power imbalance of channel reservation handshake message transfer.

According to the present invention, we consider a RTS-CTS (Ready to Send-Clear to Send) channel reservation mechanism in TV White Spaces (TVWS) and tackle the problem of the power imbalance of RTS and CTS transmissions, e.g., when fixed devices and stations (STA) are deployed on the same channel or different portable STAs have different transmit power limitations due to their geographic locations.

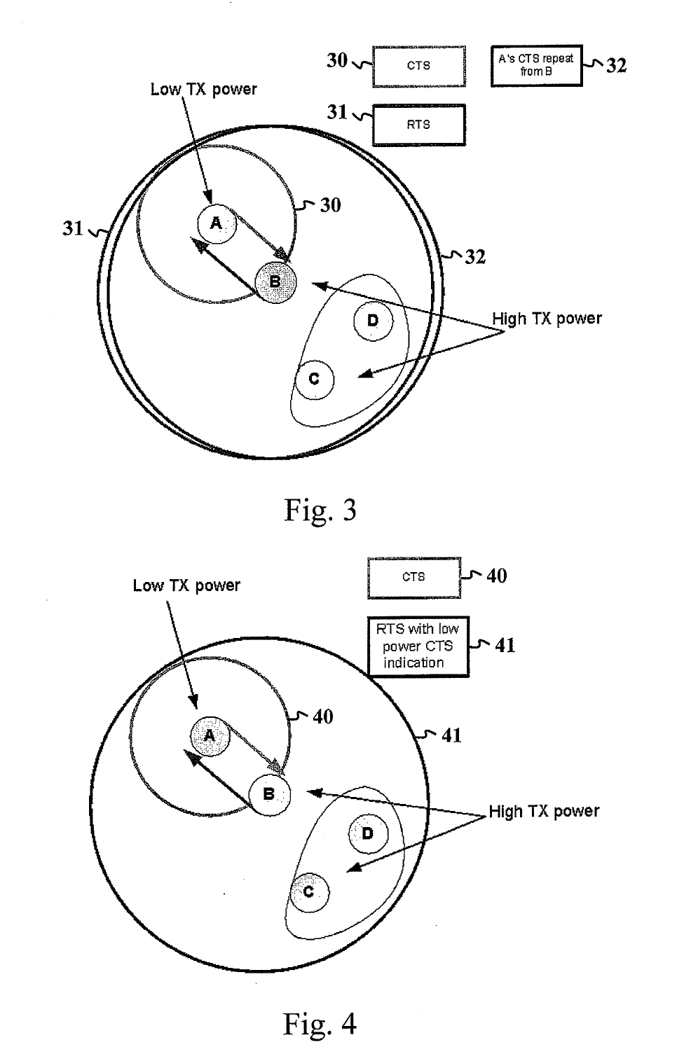

In a first embodiment of the invention, for resolving the hidden node (station) problem due to the power imbalance of the channel reservation handshake message transferring, the following option is presented. We refer to FIG. 3 in this context. As seen in the figure, station A has a low transmitting power while stations B and C have a high transmitting power. Stations C and D thus are not able to receive any signals transmitted by station A because of low RX signal level in the area of stations C and D. At first, a CTS message 30 is sent by station A which has a low transmitting power.

In this first embodiment according to the invention, station B will repeat the A's CTS message 30 with the same or approximately the same power as the RTS message 31 is transmitted. The repetition is done after a Short Interframe Space (SIFS) period upon receiving the CTS 30. The repeated CTS 32 is noticed by stations C and D and as a result, they will defer their transmissions accordingly and set the Network Allocation Vector (NAV) based on the information in the repeated CTS 32.

According to a second embodiment of the invention, we refer to FIG. 4. At first, a CTS message 40 is transmitted from station A having a low TX power, as in the first embodiment. Stations B and C have high TX powers as in FIG. 3. In the second arrangement, the station B informs in the RTS message 41 that the receiving station A has a “low TX power”. Stations C and D will receive the RTS message 41 and notice the flagged low power field and therefore, they do not expect to hear the CTS message 40. Instead, in an exemplary choice, they will wait for the time period of “SIFS+CTS+SIFS”, and thereafter, check if the station B will initiate the data transmission. If the station B does not initiate the data transmission after the specific duration, the stations C and D may access the channel because either the transmission of the RTS message 41 or the reception of the CTS message 40 has failed between stations A and B, and the data transfer between A and B will not start. Therefore, due to the RTS message 41 indicating a low power CTS, transmission from station C to D is deferred due to the low power CTS flag of the RTS message, which is received by stations C and D.

According to a further embodiment of the invention, there is a need for solving how the stations receiving the CTS message 30, 40 know about the power imbalance between the pair making the RTS-CTS handshake. It is assumed that stations A and B can resolve their power imbalance with control signaling implicitly or explicitly. One option for the power imbalance solving is that the RTS 31, 41 and/or CTS 30, 40 message shall include a device class, a transmission power class or maximum TX power of the station. Depending on the number of the indicator bits in the frame, several options are possible, e.g. a 2-bit indicator can differentiate four different power levels etc. Another option is that if the station sending the RTS message 31, 41 receives a CTS message 30, 40 which has a different (lower) power than indicated in the RTS message, the station sending the RTS message shall repeat the CTS message.

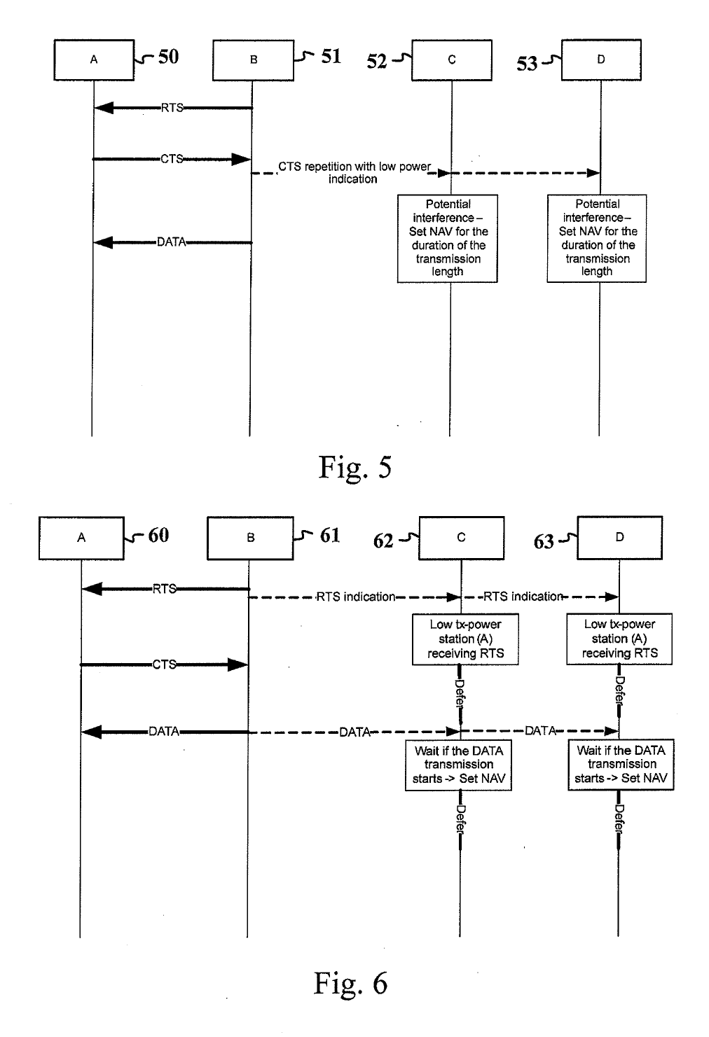

An embodiment of the implementation is shown in FIG. 5 which illustrates an exemplary signaling option in the CTS repeating case (situation corresponding to FIG. 3). As a first step of the signaling, station B 51 sends an RTS message to station A 50. After that, A 50 responds with a low-power CTS message and indicates it in the message (or the station B 51 knows this via prior signaling with station A 50). Upon receiving the CTS message, station B 51 repeats the CTS message with its own transmission power and with indication of the low-power-CTS. Thereafter, stations C 52 and D 53 pick up the CTS message and they decode the low-power-CTS message and defer their transmissions accordingly, by setting the Network Allocation Vector (NAV) for the duration of the transmission length. It can be noted that if a station 52, 53 hears an RTS message but not any CTS message, the station 52, 53 can transmit without deferring because the CTS transmitter 50, which receives data, is then located out of range.

In FIG. 6, there is illustrated a signaling option for the low-power-CTS-indication case (situation corresponding to FIG. 4). At a first step of 4). At a first step of this embodiment, station B 61 transmits an RTS message to station A 60 and indicates in the message that the receiving station is a low powered station. After that, stations C 62 and D 63 overhear this transmission from station B 61 and by detecting the low power field in the RTS message, they know that they will not necessarily hear the station A's 60 CTS response to the RTS message. Correspondingly, stations C 62 and D 63 will not immediately defer their communication for the duration indicated in the RTS but they defer it for a short duration to check whether station B 61 starts the data transmission. If station B 61 starts the data transmission, the stations C 62 and D 63 then know that the CTS reception at station B 61 was successful, and the stations C 62 and D 63 will back-off and defer their operations for the combined duration of the transmission and acknowledgement (the NAV is set). However, if the station B 61 does not start the transmission, stations C 62 and D 63 then know that the reception of either the RTS or the CTS was failed and they can start exchanging information based on the normal channel access rules.

The advantages of the present invention include the following issues. The invention solves the hidden node problem due to the power imbalance. Also, the power imbalance situation is prone to be quite frequent in the TVWS scenario due to the different requirements imposed for fixed devices and mode I/II devices. The invention solves this problem by requiring only a minor signaling effort in different apparatuses.

The inventive idea comprises the signaling and procedure according to the above, the apparatus(es) implementing the above procedures, which e.g. the station B illustrates in the above description and figures. The apparatus according to the invention may be implemented as a chipset in a suitable terminal of a mobile communication network. In an embodiment, the apparatus according to the invention is a mobile handset or a device of a WLAN network.

In an embodiment, the apparatuses, method steps (different functionalities of the stations/nodes) and the computer program according to the invention can be implemented by at least one separate or embedded hardware module for an existing mobile communication system.

A separate or an embedded control unit may perform the above mentioned method steps where applicable. In an embodiment, the apparatus comprises a memory, and at least one processor configured to execute applicable method steps according to the invention. Furthermore, the method according to the invention can be implemented with one or several computer programs which are executed in the at least one processor. The computer program(s) can be stored on at least one computer readable medium such as, for example, a memory circuit, memory card, magnetic or optical disk. Some functional entities may be implemented as program modules linked to another functional entity. The functional entities may also be stored in separate memories and executed by separate processors, which communicate, for example, via a message bus or an internal network within the network node. An example of such a message bus is the Peripheral Component Interconnect (PCI) bus.

The exemplary embodiments of the invention can be included within any suitable device, for example, including any suitable servers, workstations, PCs, laptop computers, PDAs, Internet appliances, handheld devices, cellular telephones, wireless devices, other devices, and the like, capable of performing the processes of the exemplary embodiments, and which can communicate via one or more interface mechanisms, including, for example, Internet access, telecommunications in any suitable form (for instance, voice, modem, and the like), wireless communications media, one or more wireless communications networks, cellular communications networks, 3 G communications networks, 4 G communications networks, Public Switched Telephone Network (PSTNs), Packet Data Networks (PDNs), the Internet, intranets, a combination thereof, and the like.

It is to be understood that the exemplary embodiments are for exemplary purposes, as many variations of the specific hardware used to implement the exemplary embodiments are possible, as will be appreciated by those skilled in the hardware arts. For example, the functionality of one or more of the components of the exemplary embodiments can be implemented via one or more hardware devices.

The exemplary embodiments can store information relating to various processes described herein. This information can be stored in one or more memories, such as a hard disk, optical disk, magneto-optical disk, RAM, and the like. One or more databases can store the information used to implement the exemplary embodiments of the present invention. The databases can be organized using data structures (e.g., records, tables, arrays, fields, graphs, trees, lists, and the like) included in one or more memories or storage devices listed herein. The processes described with respect to the exemplary embodiments can include appropriate data structures for storing data collected and/or generated by the processes of the devices and subsystems of the exemplary embodiments in one or more databases.

All or a portion of the exemplary embodiments can be implemented by the preparation of application-specific integrated circuits or by interconnecting an appropriate network of conventional component circuits, as will be appreciated by those skilled in the electrical arts.

As stated above, the components of the exemplary embodiments can include computer readable medium or memories according to the teachings of the present invention and for holding data structures, tables, records, and/or other data described herein. Computer readable medium can include any suitable medium that participates in providing instructions to a processor for execution. Such a medium can take many forms, including but not limited to, non-volatile media, volatile media, transmission media, and the like. Non-volatile media can include, for example, optical or magnetic disks, magneto-optical disks, and the like. Volatile media can include dynamic memories, and the like. Transmission media can include coaxial cables, copper wire, fiber optics, and the like. Transmission media also can take the form of acoustic, optical, electromagnetic waves, and the like, such as those generated during radio frequency (RF) communications, infrared (IR) data communications, and the like. Common forms of computer-readable media can include, for example, a floppy disk, a flexible disk, hard disk, magnetic tape, any other suitable magnetic medium, a CD-ROM, CDRW, DVD, any other suitable optical medium, punch cards, paper tape, optical mark sheets, any other suitable physical medium with patterns of holes or other optically recognizable indicia, a RAM, a PROM, an EPROM, a FLASH-EPROM, any other suitable memory chip or cartridge, a carrier wave or any other suitable medium from which a computer can read.

While the present inventions have been described in connection with a number of exemplary embodiments, and implementations, the present invention are not so limited, but rather cover various modifications, and equivalent arrangements, which fall within the purview of prospective claims.

It is obvious to a person skilled in the art that with the advancement of technology, the basic idea of the invention may be implemented in various ways. The invention and its embodiments are thus not limited to the examples described above; instead they may vary within the scope of the claims.

1. An apparatus, which is configured to:
receive a message which message is transmitted by a first station;
indicate from the message that the first station transmits with a lower transmitting power than the apparatus, the first station deemed as a hidden node; and
transmit information comprising an indication of the hidden node, where the indication is received by at least one other station; and as a consequence to the received indication, the at least one other station is configured to defer its data transmission.

2. The apparatus according to claim 1, the apparatus being further configured so that the indication of the hidden node is the transmission of the first station repeated by the apparatus.

3. The apparatus according to claim 2, the apparatus being further configured to transmit the information with larger power than the first station.

4. The apparatus according to claim 1, the apparatus being further configured so that the indication of the hidden node is included in a part of a transmitted message by the apparatus.

5. The apparatus according to claim 1, the apparatus being further configured so that the received message comprises information of at least one of a device class, transmission power class or maximum transmitting power of the first station.

6. The apparatus according to claim 2, the apparatus being further configured so that the transmitted information comprises power level information comprising at least one of a device class, transmission power class or maximum transmitting power of the apparatus.

7. The apparatus according to claim 6, the apparatus being further configured so that in case the power level information does not match with the power of the received message, the received message is repeated by the apparatus.

8. The apparatus according to claim 1, wherein the message transmitted by the first station is a Clear to Send message.

9. The apparatus according to claim 1, wherein the transmitted information comprises a Ready to Send message.

10. The apparatus according to claim 9, wherein the Ready to Send message is transmitted with the same power as the repeated transmission.

11. The apparatus according to claim 8, wherein the data transmission is deferred for a selectable time period.

12. The apparatus according to claim 11, where the time period is selected as two times the Short Interframe Space plus the frame duration of the Clear to Send message.

13. The apparatus according to claim 9, in case a data transmission after the Ready to Send message takes place by the apparatus, the at least one other station is configured to defer its transmission until the data transmission by the apparatus is completed and acknowledged.

14. The apparatus according to claim 1, wherein the apparatus, the first station and the at least one other station are TV Band Devices.

15. The apparatus according to claim 1, wherein the apparatus, the first station and the at least one other station are part of a Wireless Local Area Network.

16. A method, comprising:
receiving a message which message is transmitted by a first station;
indicating from the message that the first station transmits with a lower transmitting power than the apparatus, the first station deemed as a hidden node; and
transmitting information comprising an indication of the hidden node, where the indication is received by at least one other station; and as a consequence to the received indication, the at least one other station is configured to defer its data transmission.

17. The method according to claim 16, wherein further, the indication of the hidden node is the transmission of the first station repeated by the apparatus.

18. A computer program comprising code adapted to perform the following steps, when executed on a data-processing system, comprising:
receiving a message which message is transmitted by a first station;
indicating from the message that the first station transmits with a lower transmitting power than the apparatus, the first station deemed as a hidden node; and
transmitting information comprising an indication of the hidden node, where the indication is received by at least one other station; and as a consequence to the received indication, the at least one other station is configured to defer its data transmission.

19. The computer program according to claim 18, wherein further, the indication of the hidden node is the transmission of the first station repeated by the apparatus.

20. The computer program according to claim 18, wherein the computer program is stored on a computer readable medium.
